(19) United States
(12) Patent Application Publication
(10) Pub. No.: US 2026/0245229 A1
(43) Pub. Date: Aug. 20, 2026

(54) METHOD AND DEVICE FOR ESTIMATING VOLUME IN WHICH POWDERY MATERIAL IS NON-UNIFORMLY LAID

(71) Applicant: KYUNGPOOK NATIONAL UNIVERSITY INDUSTRY-ACADEMIC COOPERATION FOUNDATION, Gyeongsangbuk-do (KR)

(72) Inventors: Dong-Eun LEE, Gyeongsangbuk-do (KR); Kyuman LEE, Gyeongsangbuk-do (KR)

(73) Assignee: KYUNGPOOK NATIONAL UNIVERSITY INDUSTRY-ACADEMIC COOPERATION FOUNDATION, Gyeongsangbuk-do (KR)

(21) Appl. No.: 18/998,117

(22) PCT Filed: Jul. 26, 2023
(86) PCT No.: PCT/KR2023/010832

§ 371 Date: Jun. 19, 2025

(30) Foreign Application Priority Data
Jul. 27, 2022 (KR) 10-2022-0093254

(51) Int. Cl. G06T 7/62; G06F 18/23

(52) U.S. Cl. CPC G06T 7/62; G06F 18/23; G06T 2207/10008

(57) ABSTRACT

Disclosed are a method and device for estimating the volume in which a powdery material is non-uniformly laid. The method for estimating the volume of non-uniform arrangement comprises the steps of: acquiring scan data for the entire target area from at least one initial scan position, which is determined on the basis of the size of the target area and the field of view (FOV) of a camera that is scanning the target region; merging scan data acquired at a position moved from the at least one initial scan position by means of a three-dimensional gantry robot; generating modified scan data by removing scan points on the edges from scan points included in the merged scan data; determining an initial position of non-uniform arrangement in the target area, through a planar model determined on the basis of distances between scan points included in the modified scan data; redetermining the position to be scanned by the camera, by clustering outliers identified at the initial position of non-uniform arrangement; and determining a final position of non-uniform arrangement, by using scan data at the redetermined scan position of the camera, and estimating the volume of non-uniform arrangement at a position determined to be the final position of non-uniform arrangement.

### TECHNICAL FIELD

The present disclosure relates to a method and apparatus for estimating a non-uniform placement volume of a powder material, and more particularly, relates to a method and apparatus for identifying a non-uniform placement position of a powder material based on a computer vision technology and estimating a non-uniform placement volume for the non-uniform placement position.

### BACKGROUND ART

When there is a non-uniform placement area within a formwork, errors accumulate during the process of stacking and compacting a powder material (e.g., soil). In order to solve this problem and perform the placement uniformly, it is necessary to detect the position where the powder material is placed or compacted uniformly in advance and estimate a volume thereof.

In the related art, a method of detecting a non-uniform placement portion required a person to directly detect the non-uniform placement portion of the powder material placed inside the formwork with the naked eye, which was labor-intensive and time-consuming, and there was a problem that accuracy varied greatly depending on the user's skill level.

### DISCLOSURE OF THE INVENTION

### Technical Goals

The present disclosure provides a method and apparatus capable of detecting a non-uniform placement position more quickly and accurately by applying techniques based on a computer vision technology to scan data obtained at a first distance from a surface of a placed and compacted powder material.

The present disclosure also provides a method and apparatus capable of more accurately estimating a non-uniform placement volume corresponding to a non-uniform placement position by applying a volume estimation algorithm using scan data obtained at a second distance closer than the first distance to the detected non-uniform placement position.

### Technical Solutions

A method of estimating a non-uniform placement volume of a target region includes obtaining scan data for an entire portion of the target region in at least one initial scan position determined based on a size of the target region and a field of view (FOV) of a camera that scans the target region, stitching the scan data obtained in the at least one initial scan position that is moved by a three-dimensional (3D) gantry robot, generating modified scan data by removing scan points positioned at edges among scan points included in the stitched scan data, determining an initial non-uniform placement position where the target region is present through a plane model determined based on a distance between scan points included in the modified scan data, re-determining a scan position of the camera by clustering outliers identified in the initial non-uniform placement position, and estimating a non-uniform placement volume in a determined final non-uniform placement position by determining the final non-uniform placement position through scan data in the re-determined scan position of the camera.

For the initial scan position, a scan height may be determined based on a horizontal size and a vertical size of the target region and a horizontal FOV of the camera, and a horizontal direction scan position of the target region may be determined based on a number of shots determined using a length of an overlapping region of the scan data obtained in the at least one scan position.

The stitching may include stitching the scan data obtained in the at least one initial scan position by converting the scan data into absolute coordinates based on an origin of the 3D gantry robot.

The determining may include repeating a process of extracting random scan points from among the scan points included in the modified scan data to generate a preliminary plane, and identifying scan points present in a portion less than or equal to a predetermined distance from the generated preliminary plane, determining a preliminary plane with a maximum number of the identified scan points as the plane model among preliminary planes generated through the repeating, and identifying scan points present beyond a predetermined distance from the determined plane model as outliers corresponding to the initial non-uniform placement position.

The re-determining may include obtaining a center of each clustered outlier cluster by performing density-based clustering on scan points classified as outliers in the initial non-uniform placement position, stitching outlier clusters by performing agglomerative clustering on each outlier cluster, and re-determining a center of the stitched outlier cluster as the scan position of the camera.

The stitching may include, until the number of outlier clusters clustered through the density-based clustering is less than or equal to a predetermined number, stitching the outlier clusters in a way that dispersion between the outlier clusters increases the least.

The method may further include, when the scan position of the re-determined camera is present in a portion less than a predetermined distance from a wall, modifying so that the center of the stitched outlier cluster is beyond the predetermined distance from the wall.

The determining may further include estimating a non-uniform placement volume in the determined initial non-uniform placement position, and the re-determining may further include determining a scan height of the camera in the re-determined scan position based on the estimated non-uniform placement volume in the initial non-uniform placement position.

A method of estimating a non-uniform placement volume of a target region includes obtaining scan data in at least one scan position determined for the target region, identifying a non-uniform placement position where the target region is present through a plane model determined based on a distance between scan points included in the obtained scan data, generating height difference information between scan points corresponding to the identified non-uniform placement position and the plane model, measuring an individual volume for each grid cell by grouping the scan points, for which the height difference information is generated, for each grid cell, and estimating a non-uniform placement volume of an entire portion of the non-uniform placement position by summing the measured individual volume for each grid cell.

The identifying may include repeating a process of extracting random scan points from among the scan points included in the obtained scan data to generate a preliminary plane, and identifying scan points present in a portion less than or equal to a predetermined distance from the generated preliminary plane, determining a preliminary plane with a maximum number of the identified scan points as the plane model among preliminary planes generated through the repeating, and classifying scan points present beyond a predetermined distance from the determined plane model as outliers corresponding to the non-uniform placement position.

The generating may include, when a height difference between the scan point corresponding to the non-uniform placement position and one point of the plane model is within a preset error range, setting the height difference of the scan point as 0.

A non-uniform placement volume estimation apparatus for performing a method of estimating a non-uniform placement volume of a target region includes a processor. The processor is configured to obtain scan data for an entire portion of the target region in at least one initial scan position determined based on a size of the target region and a FOV of a camera that scans the target region, stitch the scan data obtained in the at least one initial scan position that is moved by a 3D gantry robot, generate modified scan data by removing scan points positioned at edges among scan points included in the stitched scan data, determine an initial non-uniform placement position where the target region is present through a plane model determined based on a distance between scan points included in the modified scan data, re-determine a scan position of the camera by clustering outliers identified in the initial non-uniform placement position, and estimate a non-uniform placement volume in a determined final non-uniform placement position by determining the final non-uniform placement position through scan data in the re-determined scan position of the camera.

For the initial scan position, a scan height may be determined based on a horizontal size and a vertical size of the target region and a horizontal FOV of the camera, and a horizontal direction scan position of the target region may be determined based on a number of shots determined using a length of an overlapping region of the scan data obtained in the at least one scan position.

The processor may be configured to stitch the scan data obtained in the at least one initial scan position by converting the scan data into absolute coordinates based on an origin of the 3D gantry robot.

The processor may be configured to repeat a process of extracting random scan points from among the scan points included in the modified scan data to generate a preliminary plane, and identifying scan points present in a portion less than or equal to a predetermined distance from the generated preliminary plane, determine a preliminary plane with a maximum number of the identified scan points as the plane model among preliminary planes generated through the repeating, and identify scan points present beyond a predetermined distance from the determined plane model as outliers corresponding to the initial non-uniform placement position.

The processor may be configured to obtain a center of each clustered outlier cluster by performing density-based clustering on scan points classified as outliers in the initial non-uniform placement position, stitch outlier clusters by performing agglomerative clustering on each outlier cluster, and re-determine a center of the stitched outlier cluster as the scan position of the camera.

The processor may be configured to, until the number of outlier clusters clustered through the density-based clustering is less than or equal to a predetermined number, stitch the outlier clusters in a way that dispersion between the outlier clusters increases the least.

The processor may be configured to, when the scan position of the re-determined camera is present in a portion less than a predetermined distance from a wall, modify so that the center of the stitched outlier cluster is beyond the predetermined distance from the wall.

The processor may be configured to estimate a non-uniform placement volume in the determined initial non-uniform placement position, and determine a scan height of the camera in the re-determined scan position based on the estimated non-uniform placement volume in the initial non-uniform placement position.

### Effects of the Invention

According to an embodiment of the present disclosure, a non-uniform placement position may be detected more quickly and accurately by applying techniques based on a computer vision technology to scan data obtained at a first distance from a surface of a placed and compacted powder material.

In addition, according to an embodiment of the present disclosure, a non-uniform placement volume corresponding to a non-uniform placement position may be more accurately estimated by applying a volume estimation algorithm using scan data obtained at a second distance closer than the first distance to the detected non-uniform placement position.

### BRIEF DESCRIPTION OF DRAWINGS

FIG. 1 is a diagram illustrating a non-uniform placement volume estimation system of a target region according to an embodiment of the present

### DISCLOSURE

FIG. 2 is a diagram illustrating a method of estimating a non-uniform placement volume performed by a non-uniform placement volume estimation apparatus according to an embodiment of the present disclosure.

FIG. 3 is a diagram illustrating results of stitching of scan data obtained at each scan position when the number of shots is 2 according to an embodiment of the present disclosure.

FIG. 4 is a diagram illustrating scan data modified by removing outliers detected on a wall according to an embodiment of the present disclosure.

FIG. 5 is a diagram illustrating a plane model determined through a RANdom SAmple Consensus (RANSAC) algorithm and an outlier classified using the plane model according to an embodiment of the present disclosure.

FIG. 6 is a diagram illustrating a result of clustering scan points classified as outliers through a density-based spatial clustering of applications with noise (DBSCAN) algorithm and a center of scan points classified as clustered outlier.

FIG. 7 is a diagram illustrating a center of clustering scan points classified as outliers using a DBSCAN algorithm and a result of stitching clusters using an agglomerative clustering method.

FIG. 8 is a diagram specifically illustrating a method of estimating a non-uniform placement volume according to an embodiment of the present disclosure.

### BEST MODE FOR CARRYING OUT THE INVENTION

Hereinafter, embodiments will be described in detail with reference to the accompanying drawings.

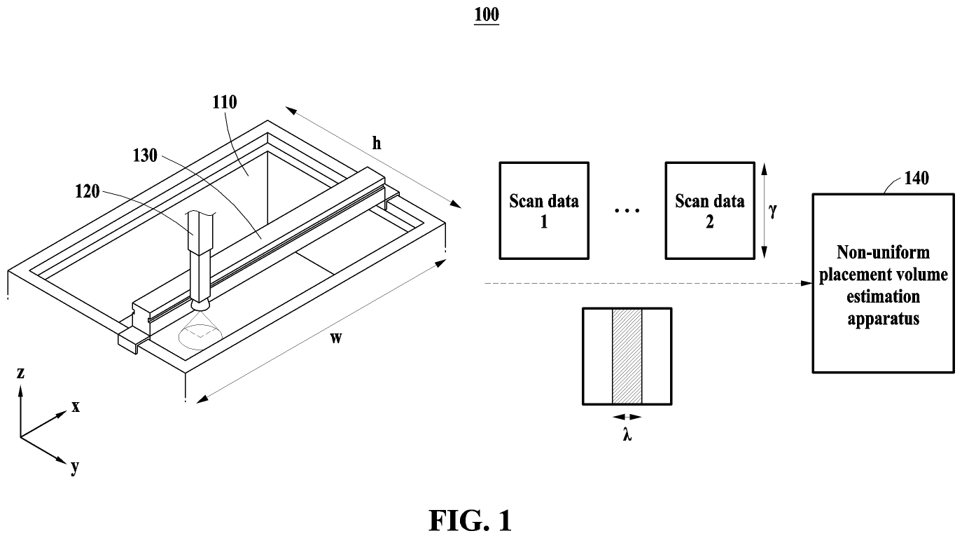

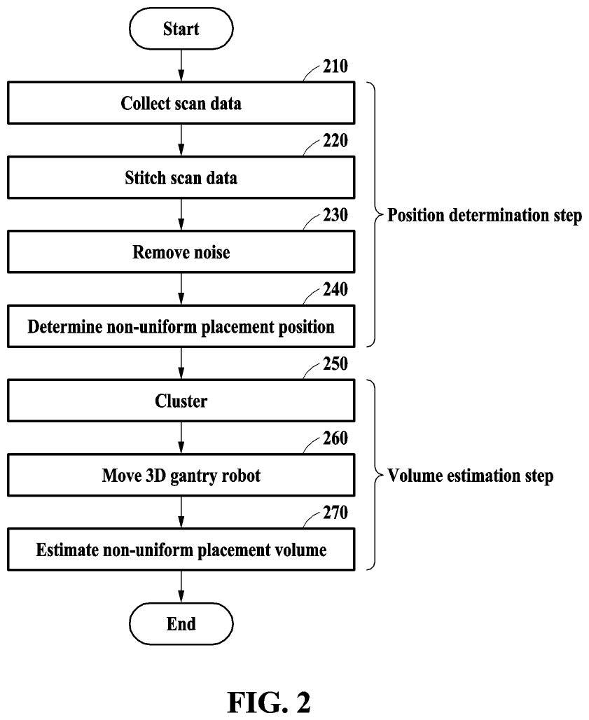

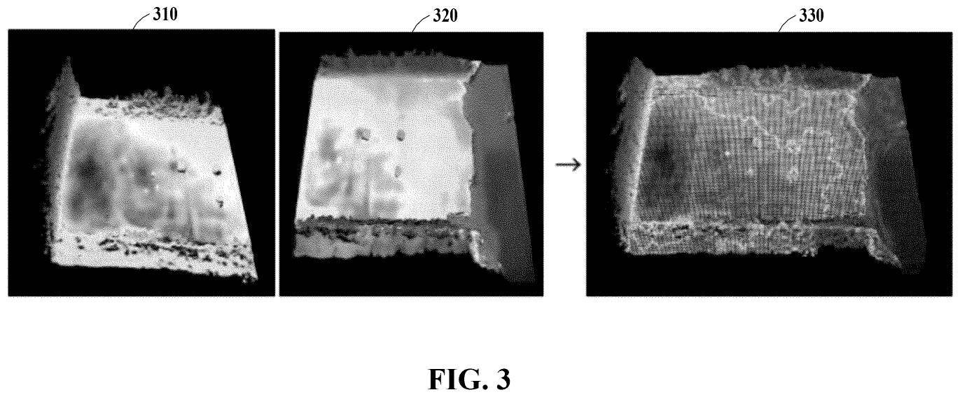

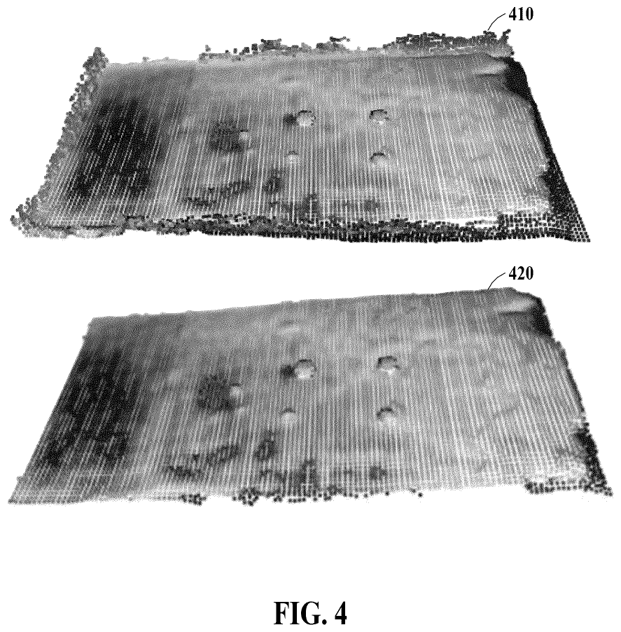

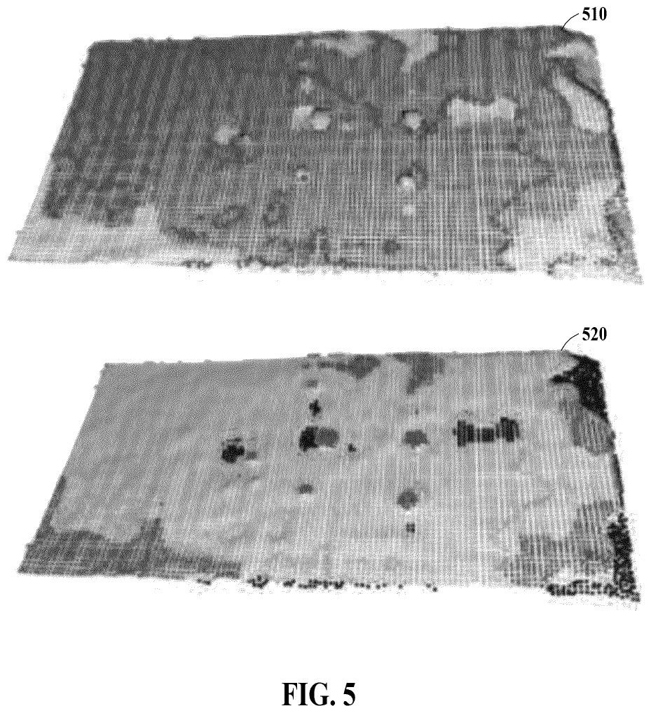

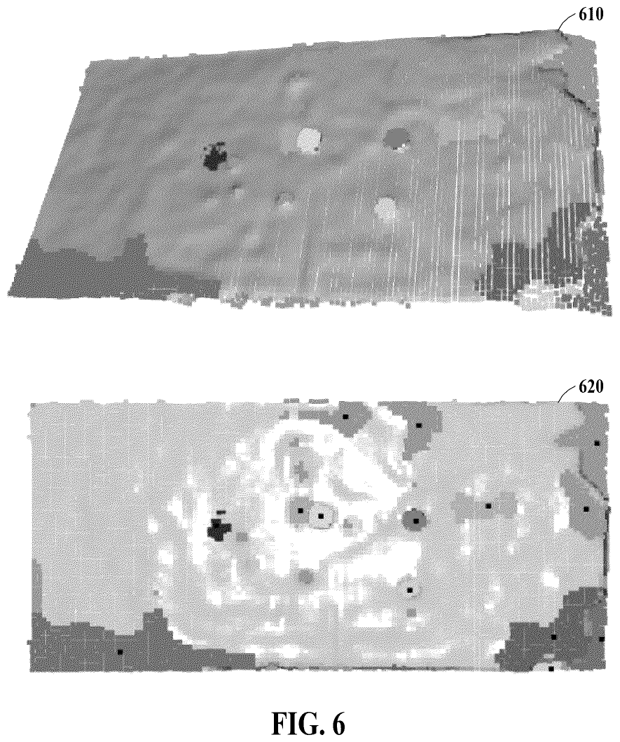

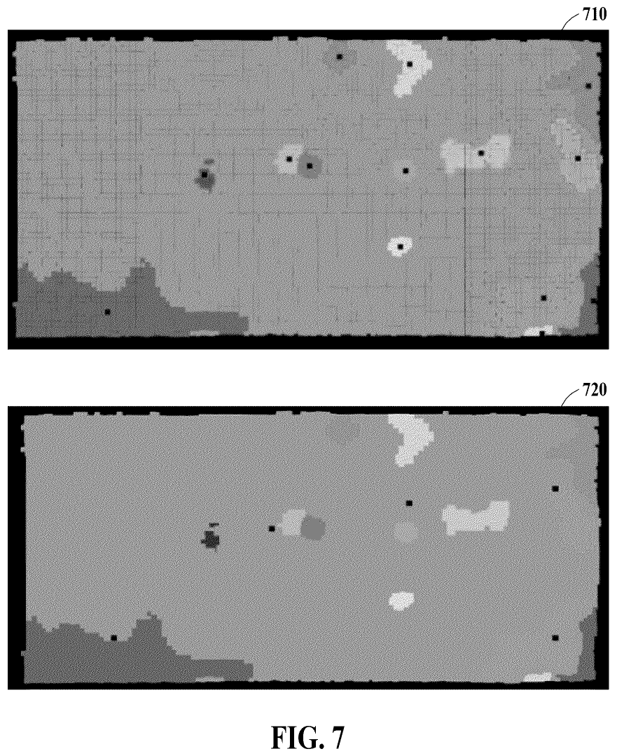

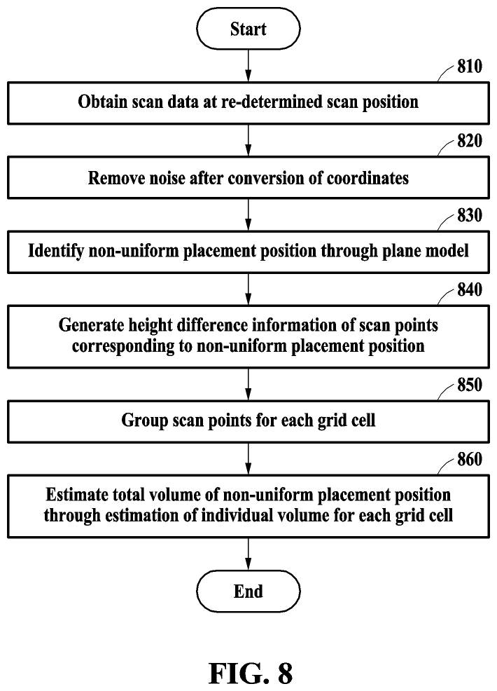

FIG. 1 is a diagram illustrating a non-uniform placement volume estimation system of a target region according to an embodiment of the present disclosure.

Referring to FIG. 1, a non-uniform placement volume estimation system 100 of the present disclosure may include a hexahedral formwork 110 having a bottom surface, on which a powder material is placed and compacted, and a three-dimensional (3D) gantry robot 130 which is disposed on an upper end of the formwork 110 to move a camera 120 for obtaining scan data for the powder material placed on the bottom surface of the formwork 110.

At this time, the non-uniform placement volume estimation system 100 may further include a non-uniform placement volume estimation apparatus 140, and the non-uniform placement volume estimation apparatus 140 may be disposed, for example, in the 3D gantry robot 130. The non-uniform placement volume estimation apparatus 140 may receive scan data for the powder material placed on the bottom surface of the formwork 110 obtained through the camera 120 wirelessly or by wire, and measure non-uniform placement of the powder material placed on the bottom surface of the formwork 110 based on the received scan data. Here, the non-uniform placement may refer to a region where the powder material placed on the bottom surface of the formwork 110 is placed non-uniformly.

For example, the formwork 110 may have a hexahedral shape with a length of 120 centimeters (cm), a width of 60 cm, and a height of 90 cm, and it is assumed that soil, which is the powder material, is placed flat on the bottom surface to a height of about 20 cm. However, various types of powder materials such as concrete, asphalt concrete, waterproof paint, and the like, as well as soil, may be placed on the bottom surface of the formwork 110.

The camera 120 mounted on the 3D gantry robot 130 may be a light detection and ranging (lidar) sensor, and the scan data obtained through the camera 120 may be a type of point cloud data. However, the camera 120 is not limited to a lidar sensor, and any type of sensor capable of obtaining 3D scan data for the powder material may be used.

The 3D gantry robot 130 may move the camera 120 along 3D axes (x-axis, y-axis, and z-axis) to obtain the scan data for the powder material placed on the bottom surface of a formwork 110.

In this way, the non-uniform placement volume estimation apparatus 140 may measure a non-uniform placement position for the powder material placed on the bottom surface of the formwork 110 using the scan data obtained from the camera 120 mounted on the 3D gantry robot 130, and estimate a non-uniform placement volume for the measured non-uniform placement position.

At this time, the non-uniform placement volume estimation apparatus 140 may control the operations of the camera 120 and the 3D gantry robot 130 to estimate the non-uniform placement volume for the non-uniform placement position. A method of estimating a non-uniform placement volume performed by the non-uniform placement volume estimation apparatus 140 will be described in detail with reference to the following drawings.

FIG. 2 is a diagram illustrating a method of estimating a non-uniform placement volume performed by a non-uniform placement volume estimation apparatus according to an embodiment of the present disclosure.

Referring to FIG. 2, the method of estimating the non-uniform placement volume performed by the non-uniform placement volume estimation apparatus 140 of the present disclosure may largely include two steps of a position determination step and a volume estimation step.

More specifically, the position determination step may include four operations of 1) scan data collection, 2) stitching of collected scan data, 3) noise removal, and 4) non-uniform placement position determination, and the volume estimation step may include three operations of 1) hierarchical clustering, 2) 3D gantry robot movement, and 3) non-uniform placement volume estimation.

First, in operation 210, the non-uniform placement volume estimation apparatus 140 may obtain scan data for an entire portion of the bottom surface of the formwork 110 by controlling the movement of the 3D gantry robot 130 based on one or more scan positions determined based on a size of the formwork 110 and a field of view (FOV) of the camera 120 that scans the formwork 110.

At this time, the camera 120 may be installed vertically on the bottom surface of the formwork 110, and the scan data for the entire portion of the bottom surface may be collected by capturing segment images of the bottom surface of the formwork 110 according to the movement of the 3D gantry robot 130.

For example, as in FIG. 1, when a horizontal (x-axis) FOV of the camera 120 is defined as α, a vertical (y-axis) FOV of the camera 120 is defined as β, a horizontal (x-axis) size of the formwork 110 is defined as w, and a vertical (y-axis) size of the formwork 110 is defined as h, it is necessary to satisfy w>h, and a minimum scan height d of the camera 120 that satisfies this condition may be obtained by Equation 1 below.

$$d \times tan ( α / 2 ) \times 2 \geq h \qquad [ Equation 1 ]$$

$$d \geq \frac{h}{tan ( α / 2 ) \times 2}$$

At this time, a vertical length γ of the scan data obtained through the camera 120 may be as shown in Equation 2 below.

$$γ = d \times tan ( β / 2 ) \times 2 \qquad [ Equation 2 ]$$

Here, a length of an overlapping portion between the pieces of scan data obtained through the camera 120 is defined as λ. The non-uniform placement volume estimation apparatus 140 may use the λ determined in this manner to obtain the approximate number of shots n of the camera 120 by Equation 3 below.

$$γ + ( γ - λ ) \times ( n - 1 ) \geq ω \qquad [ Equation 3 ]$$

$$n \geq \frac{ω - γ}{γ - λ} + 1$$

The non-uniform placement volume estimation apparatus 140 may determine coordinates of an initial scan position of the camera 120 using the number of shots obtained as described above. As mentioned above, in order to obtain the scan data for the entire portion of the bottom surface of the formwork 110, the 3D gantry robot 130 equipped with the camera 120 has its vertical (y-axis) coordinate fixed and may only move in the horizontal direction (x-axis). In other words, the vertical (y-axis) coordinate of the camera 120 may be fixed to h/2, and a height (z-axis) coordinate may be fixed to any point equal to or higher than the minimum scan height d.

The horizontal (x-axis) coordinate of the camera 120 may be determined by Equation 4 below by obtaining an interval value (interval=w/(n+1)) of the camera 120 using the number of shots obtained by Equation 3, and adding the interval value obtained at the edge of the formwork 110 one by one.

$${x}_{i} = interval \times i , 1 \leq i \leq n \qquad [ Equation 4 ]$$

In operation 220, the non-uniform placement volume estimation apparatus 140 may stitch the scan data obtained in at least one scan position. At this time, the scan data obtained in the at least one scan position may not be registered because the reference coordinate systems are different. Therefore, the non-uniform placement volume estimation apparatus 140 may stitch the scan data obtained in the at least one scan position by converting the scan data into absolute coordinates based on an origin of the 3D gantry robot 130.

As an example, FIG. 3 illustrates results of stitching of scan data obtained at each scan position when the number of shots is 2 according to an embodiment of the present disclosure. As described above, the vertical (y-axis) coordinate of the camera 120 may be fixed to h/2, and the height (z-axis) coordinate thereof may be fixed to any point equal to or higher than the minimum scan height d. At this time, when the number of shots is 2, the horizontal (x-axis) coordinate of the camera 120 may be w/3 and 2w/3 according to Equation 4. That is, a diagram 310 of FIG. 3 is scan data obtained when the horizontal (x-axis) coordinate of the camera 120 is w/3, and a diagram 320 of FIG. 3 is scan data obtained when the horizontal (x-axis) coordinate of the camera 120 is 2w/3.

The non-uniform placement volume estimation apparatus 140 may obtain switched scan data as in a diagram 330 of FIG. 3 by converting each scan data obtained as described above into absolute coordinates based on an origin of the 3D gantry robot 130.

In operation 230, the non-uniform placement volume estimation apparatus 140 may generate modified scan data by removing scan points positioned at edges among scan points included in the stitched scan data. This is to remove noise, i.e., scan points detected on a wall surface rather than the bottom surface of the formwork 110 to be detected in the present disclosure from the stitched scan data.

For this, the non-uniform placement volume estimation apparatus 140 may remove the scan points positioned at the edges of the stitched scan data based on a given user range. For example, a diagram 410 of FIG. 4 is a result of stitching the scan data obtained at each scan position, and a diagram 420 of FIG. 4 may show scan data modified by removing the scan points on the wall surface corresponding to the noise from among the stitched scan data.

In operation 240, the non-uniform placement volume estimation apparatus 140 may determine an initial non-uniform placement position present on the bottom surface of the formwork 110 through a plane model determined based on a distance between scan points included in the modified scan data.

More specifically, the non-uniform placement volume estimation apparatus 140 may repeat a process of extracting random scan points from among the scan points included in the modified scan data to generate a preliminary plane, and identifying scan points present in a portion less than or equal to a predetermined distance from the generated preliminary plane.

Thereafter, the non-uniform placement volume estimation apparatus 140 may determine the preliminary plane with a maximum number of the identified scan points as the plane model among preliminary planes generated through the repeating. Here, the non-uniform placement volume estimation apparatus 140 may classify scan points within a threshold value as inliers using the determined plane model, and classify scan points exceeding the threshold value as outliers.

For example, a diagram 510 of FIG. 5 shows a plane model determined through a RANdom SAmple Consensus (RANSAC) algorithm according to an embodiment of the present disclosure, and a diagram 520 of FIG. 5 shows an outlier classified using the plane model. At this time, it may be confirmed that the scan points exceeding the threshold value in the +z-axis direction based on the plane model are classified as hills among the outliers, and the scan points exceeding the threshold value in the −z-axis direction are classified as holes among the outliers. At this time, as the algorithm used to determine the plane model, the RANSAC algorithm is merely an example and is not limited thereto.

Meanwhile, the non-uniform placement volume estimation apparatus 140 may estimate the non-uniform placement volume for the determined initial non-uniform placement position. The non-uniform placement volume for the initial non-uniform placement position estimated in this way may be utilized in subsequent operations.

In operation 250, the non-uniform placement volume estimation apparatus 140 may re-determining a scan position of the camera 120 by clustering outliers identified in the initial non-uniform placement position. The scan data obtained in operation 210 may be data obtained from the camera 120 spaced apart from a surface of the powder material placed on the bottom surface of the formwork 110 by a first distance. The scan data obtained at the first distance may be used to determine the non-uniform placement position for the powder material placed on the bottom surface of the formwork 110, but may not have sufficient information to estimate the non-uniform placement volume for the determined non-uniform placement position.

Accordingly, the non-uniform placement volume estimation apparatus 140 of the present disclosure may re-determine the scan position of the camera 120 so as to obtain more detailed scan data for the non-uniform placement position in order to more accurately estimate the non-uniform placement volume for the non-uniform placement position.

For this, the non-uniform placement volume estimation apparatus 140 may perform density-based clustering on the scan points classified as the outliers, and obtain a center of each clustered outlier cluster. For example, a diagram 610 of FIG. 6 shows a result of clustering the scan points classified as the outliers through a density-based spatial clustering of applications with noise (DBSCAN) algorithm according to an embodiment of the present disclosure, and a diagram 620 of FIG. 6 is a diagram showing the center of each clustered outlier cluster. At this time, as the algorithm to cluster the scan points, the DBSCAN algorithm is merely an example and is not limited thereto.

The coordinates of the center of each clustered outlier cluster may be transmitted to the 3D gantry robot 130, and the non-uniform placement volume estimation apparatus 140 may estimate a more accurate non-uniform placement volume for the non-uniform placement position using the scan data of the camera 120 which is re-obtained at the scan position moved by the 3D gantry robot 130.

At this time, the scan data obtained to estimate the non-uniform placement volume may be data obtained from a camera 120 spaced apart from the surface of the powder material placed on the bottom surface of the formwork 110 by a second distance shorter than the first distance. That is, the non-uniform placement volume estimation apparatus 140 may estimate the non-uniform placement volume more accurately by using the scan data captured at a closer distance to the non-uniform placement position. For this, the non-uniform placement volume estimation apparatus 140 may determine the scan height of the camera 120 at the re-determined scan position based on the non-uniform placement volume estimated for the initial non-uniform placement position.

However, if there are a large number of outlier clusters, it is inefficient for the 3D gantry robot 130 to move to all the outlier clusters, and if the coordinates of the center of the outlier cluster are close to the wall, it is necessary to modify the coordinates of the center of the outlier cluster because it is difficult for the 3D gantry robot 130 to move toward the wall.

Accordingly, the non-uniform placement volume estimation apparatus 140 of the present disclosure may once again perform agglomerative clustering among hierarchical clustering for each outlier cluster clustered through the density-based clustering. For example, a diagram 710 of FIG. 7 shows the center of an outlier cluster that is obtained by clustering scan points classified as outliers using the DBSCAN algorithm, which is a density-based clustering method according to an embodiment of the present disclosure, and a diagram 720 of FIG. 7 shows a result of stitching two outlier clusters that increase the dispersion among all outlier clusters to the smallest extent using the agglomerative clustering method, and repeating this process until only five outlier clusters remain.

At this time, if the center of the outlier cluster stitched through the agglomerative clustering is very close to the wall, the movement of the 3D gantry robot 130 is restricted, and thus, the non-uniform placement volume estimation apparatus 140 may modify the coordinates of the center of the stitched outlier cluster so as to be spaced apart from the wall at a predetermined distance (e.g., 10 cm) or more by considering the movement of the 3D gantry robot 130.

As described above, the non-uniform placement volume estimation apparatus 140 may stitch the outlier clusters through the agglomerative clustering, and re-determine the scan position of the camera 120 for estimating the non-uniform distribution volume through the modification of the coordinates of the center of the stitched outlier clusters.

In operation 260, the non-uniform placement volume estimation apparatus 140 may control the movement of the 3D gantry robot 130 based on the scan position of the camera 120 re-determined as described above, and in operation 270, the non-uniform placement volume estimation apparatus 140 may estimate the non-uniform placement volume with higher accuracy through the scan data obtained at the re-determined scan position of the camera 120.

FIG. 8 is a diagram specifically illustrating a method of estimating a non-uniform placement volume according to an embodiment of the present disclosure.

In operation 810, the non-uniform placement volume estimation apparatus 140 may obtain scan data at the re-determined scan position of the camera 120 by controlling the 3D gantry robot 130. At this time, the obtained scan data may be data measured at a closer distance from the non-uniform placement position than the scan data obtained at the initial scan position.

In operation 820, the non-uniform placement volume estimation apparatus 140 may remove noise after converting the obtained scan data into absolute coordinates using an origin of the 3D gantry robot 130.

In operation 830, the non-uniform placement volume estimation apparatus 140 may determine the plane model based on the distance between scan points included in the scan data, from which the noise is removed, and then, identify the non-uniform placement position on the bottom surface of the formwork 110.

In operation 840, the non-uniform placement volume estimation apparatus 140 may generate height difference information between the plane model and the scan points corresponding to the identified non-uniform placement position. For example, the equation of the plane model may be presented as ax+by+cz+d=0, where the constants a, b, c, and d may have given values. At this time, if it is assumed that the coordinates of the scan point corresponding to the non-uniform placement position are (i, j, k), the coordinates of one point of the plane model are (w, q, l), and w=i, and q=j, l may be as shown in Equation 5 below.

$$a ω + bq + cl + d = 0 \qquad [ Equation 5 ]$$

$$l = ( - a ω - bq - d ) / c$$

Therefore, a height difference between the scan point (i, j, k) corresponding to the non-uniform placement position and a point (w, q, l) on the plane model may be 1−k. At this time, the non-uniform placement volume estimation apparatus 140 may set the height difference of the corresponding scan point to 0 when the height difference 1−k is within a preset error range, and may generate the height difference 1−k as the height difference information of the corresponding scan point when height difference 1−k exceeds the preset error range. The non-uniform placement volume estimation apparatus 140 may generate the height difference information by repeating the corresponding operation for all scan points corresponding to the non-uniform placement position.

In operation 850, the non-uniform placement volume estimation apparatus 140 may generate a grid for the scan points where the height difference information is generated, and group the scan points for each generated grid cell.

In operation 860, the non-uniform placement volume estimation apparatus 140 may measure individual volumes for each grid cell using the height difference information for each of the scan points grouped for each grid cell, and may estimate a total volume for the non-uniform placement position by summing all the measured individual volumes for each grid cell. At this time, the non-uniform placement volume estimation apparatus 140 may use only grid cells in which a predetermined number of scan points exist among grid cells for the volume estimation, and may not use grid cells in which the scan points exist for the volume estimation.

When it is assumed that n scan points exist in one of grid cells, each scan point may include height difference information with respect to the plane model. At this time, since it is assumed that the scan points are uniformly distributed, the non-uniform placement volume estimation apparatus 140 may divide the grid cells as n squares, and the height difference information of the scan points belonging to a square may exist in each square.

Therefore, the non-uniform placement volume estimation apparatus 140 may obtain the individual volume for the corresponding grid cell by summing the volume for each of the n square columns. When the area of each column is 1/ncm² and the height thereof is d, the individual volume of the grid cell may be as shown in Equation 6 below.

$$V = {\sum }_{i = 1}^{n} \frac{1}{n} \times {d}_{i} = \frac{1}{n} {\sum }_{i = 1}^{n} \times {d}_{i} \qquad [ Equation 6 ]$$

That is, the height is averaged and multiplied by 1 cm² to obtain the individual volume of the corresponding grid cell. At this time, when the non-uniform placement position is scanned at multiple scan positions, some grid cells may already have individual volume values, and in such a case, an average of the existing individual volume value and the newly obtained individual volume value may be determined as the individual volume value of the corresponding grid cell.

However, the method of determining the non-uniform placement volume is not limited to the above example, and various methods may be used. For example, the non-uniform placement volume estimation apparatus 140 may form a mesh by applying a ball-pivoting algorithm or a surface reconstruction algorithm to scan points corresponding to the non-uniform placement position, and estimate the non-uniform placement volume using the formed mesh, thereby determining a more accurate volume value.

The method according to embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The implementations may be achieved as a computer program product, i.e., a computer program tangibly embodied in an information carrier, e.g., in a machine-readable storage device (for example, a computer-readable medium) or in a propagated signal, for processing by, or to control an operation of, a data processing apparatus, e.g., a programmable processor, a computer, or multiple computers. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer may also include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific embodiments, the details should not be construed as limiting any invention or a scope that may be claimed, but rather should be construed as being descriptions of features that may be peculiar to specific embodiments of specific inventions. Specific features described in the present specification in the context of individual embodiments may be combined and implemented in a single embodiment. On the contrary, various features described in the context of a single embodiment may be implemented in a plurality of embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or all the shown operations must be performed in order to obtain a preferred result. In specific cases, multitasking and parallel processing may be advantageous. In addition, it should not be understood that the separation of various device components of the aforementioned embodiments is required for all the embodiments, and it should be understood that the aforementioned program components and apparatuses may be integrated into a single software product 5 or packaged into multiple software products.

The embodiments disclosed in the present specification and the drawings are intended merely to present specific examples in order to aid in understanding of the disclosure, but are not intended to limit the scope of the disclosure. It will be apparent to those skilled in the art that various modifications based on the technical spirit of the disclosure, as well as the disclosed embodiments, may be made.

1. A method of estimating a non-uniform placement volume of a target region, the method comprising:
obtaining scan data for an entire portion of the target region in at least one initial scan position determined based on a size of the target region and a field of view (FOV) of a camera that scans the target region;
stitching the scan data obtained in the at least one initial scan position that is moved by a three-dimensional (3D) gantry robot;
generating modified scan data by removing scan points positioned at edges among scan points included in the stitched scan data;
determining an initial non-uniform placement position where the target region is present through a plane model determined based on a distance between scan points included in the modified scan data;
re-determining a scan position of the camera by clustering outliers identified in the initial non-uniform placement position; and
estimating a non-uniform placement volume in a determined final non-uniform placement position by determining the final non-uniform placement position through scan data in the re-determined scan position of the camera.

2. The method of claim 1, wherein, for the initial scan position,
a scan height is determined based on a horizontal size and a vertical size of the target region and a horizontal FOV of the camera, and
a horizontal direction scan position of the target region is determined based on a number of shots determined using a length of an overlapping region of the scan data obtained in the at least one scan position.

3. The method of claim 1, wherein the stitching comprises stitching the scan data obtained in the at least one initial scan position by converting the scan data into absolute coordinates based on an origin of the 3D gantry robot.

4. The method of claim 1, wherein the determining comprises:
repeating a process of extracting random scan points from among the scan points included in the modified scan data to generate a preliminary plane, and identifying scan points present within a predetermined distance from the generated preliminary plane;
determining a preliminary plane with a maximum number of the identified scan points as the plane model among preliminary planes generated through the repeating; and
identifying scan points present beyond a predetermined distance from the determined plane model as outliers corresponding to the initial non-uniform placement position.

5. The method of claim 1, wherein the re-determining comprises:
obtaining a center of each clustered outlier cluster by performing density-based clustering on scan points classified as outliers in the initial non-uniform placement position;
stitching outlier clusters by performing agglomerative clustering on each outlier cluster; and
re-determining a center of the stitched outlier cluster as the scan position of the camera.

6. The method of claim 5, wherein the stitching comprises, until the number of outlier clusters clustered through the density-based clustering is less than or equal to a predetermined number, stitching the outlier clusters in a way that dispersion between the outlier clusters increases the least.

7. The method of claim 5, further comprising:
when the scan position of the re-determined camera is present in a portion less than a predetermined distance from a wall, modifying so that the center of the stitched outlier cluster is beyond the predetermined distance from the wall.

8. The method of claim 1, wherein
the determining further comprises estimating a non-uniform placement volume in the determined initial non-uniform placement position, and
the re-determining further comprises determining a scan height of the camera in the re-determined scan position based on the estimated non-uniform placement volume in the initial non-uniform placement position.

9. A method of estimating a non-uniform placement volume of a target region, the method comprising:
obtaining scan data in at least one scan position determined for the target region;
identifying a non-uniform placement position where the target region is present through a plane model determined based on a distance between scan points included in the obtained scan data;
generating height difference information between scan points corresponding to the identified non-uniform placement position and the plane model;
measuring an individual volume for each grid cell by grouping the scan points, for which the height difference information is generated, for each grid cell; and
estimating a non-uniform placement volume of an entire portion of the non-uniform placement position by summing the measured individual volume for each grid cell.

10. The method of claim 9, wherein the identifying comprises:
repeating a process of extracting random scan points from among the scan points included in the obtained scan data to generate a preliminary plane, and identifying scan points present in a portion less than or equal to a predetermined distance from the generated preliminary plane;
determining a preliminary plane with a maximum number of the identified scan points as the plane model among preliminary planes generated through the repeating; and
classifying scan points present beyond a predetermined distance from the determined plane model as outliers corresponding to the non-uniform placement position.

11. The method of claim 9, wherein the generating comprises, when a height difference between the scan point corresponding to the non-uniform placement position and one point of the plane model is within a preset error range, setting the height difference of the scan point as 0.

12. A non-uniform placement volume estimation apparatus for performing a method of estimating a non-uniform placement volume of a target region, the non-uniform placement volume estimation apparatus comprising:
a processor,
wherein the processor is configured to obtain scan data for an entire portion of the target region in at least one initial scan position determined based on a size of the target region and a field of view (FOV) of a camera that scans the target region, stitch the scan data obtained in the at least one initial scan position that is moved by a three-dimensional (3D) gantry robot, generate modified scan data by removing scan points positioned at edges among scan points included in the stitched scan data, determine an initial non-uniform placement position where the target region is present through a plane model determined based on a distance between scan points included in the modified scan data, re-determine a scan position of the camera by clustering outliers identified in the initial non-uniform placement position, and estimate a non-uniform placement volume in a determined final non-uniform placement position by determining the final non-uniform placement position through scan data in the re-determined scan position of the camera.

13. The non-uniform placement volume estimation apparatus of claim 12, wherein, for the initial scan position,
a scan height is determined based on a horizontal size and a vertical size of the target region and a horizontal FOV of the camera, and
a horizontal direction scan position of the target region is determined based on a number of shots determined using a length of an overlapping region of the scan data obtained in the at least one scan position.

14. The non-uniform placement volume estimation apparatus of claim 12, wherein the processor is configured to stitch the scan data obtained in the at least one initial scan position by converting the scan data into absolute coordinates based on an origin of the 3D gantry robot.

15. The non-uniform placement volume estimation apparatus of claim 12, wherein the processor is configured to repeat a process of extracting random scan points from among the scan points included in the modified scan data to generate a preliminary plane, and identifying scan points present in a portion less than or equal to a predetermined distance from the generated preliminary plane, determine a preliminary plane with a maximum number of the identified scan points as the plane model among preliminary planes generated through the repeating, and identify scan points present beyond a predetermined distance from the determined plane model as outliers corresponding to the initial non-uniform placement position.

16. The non-uniform placement volume estimation apparatus of claim 12, wherein the processor is configured to obtain a center of each clustered outlier cluster by performing density-based clustering on scan points classified as outliers in the initial non-uniform placement position, stitch outlier clusters by performing agglomerative clustering on each outlier cluster, and re-determine a center of the stitched outlier cluster as the scan position of the camera.

17. The non-uniform placement volume estimation apparatus of claim 16, wherein the processor is configured to, until the number of outlier clusters clustered through the density-based clustering is less than or equal to a predetermined number, stitch the outlier clusters in a way that dispersion between the outlier clusters increases the least.

18. The non-uniform placement volume estimation apparatus of claim 16, wherein the processor is configured to, when the scan position of the re-determined camera is present in a portion less than a predetermined distance from a wall, modify so that the center of the stitched outlier cluster is beyond the predetermined distance from the wall.

19. The non-uniform placement volume estimation apparatus of claim 12, wherein the processor is configured to estimate a non-uniform placement volume in the determined initial non-uniform placement position, and determine a scan height of the camera in the re-determined scan position based on the estimated non-uniform placement volume in the initial non-uniform placement position.
